(19) United States
(12) Patent Application Publication
(10) Pub. No.: US 2025/0068328 A1
(43) Pub. Date: Feb. 27, 2025

(54) INFORMATION PROCESSING METHOD AND APPARATUS, AND STORAGE MEDIUM

(71) Applicants: CHINA MOBILE (SUZHOU) SOFTWARE TECHNOLOGY CO., LTD., Suzhou, Jiangsu (CN); CHINA MOBILE COMMUNICATIONS GROUP CO., LTD, Beijing (CN)

(72) Inventor: Gang HUANG, Suzhou (CN)

(21) Appl. No.: 18/718,891

(22) PCT Filed: Nov. 9, 2022
(86) PCT No.: PCT/CN2022/130931

§ 371 Date: Jun. 12, 2024

(30) Foreign Application Priority Data
Dec. 16, 2021 (CN) 202111542702.9

(51) Int. Cl. G06F 3/06

(52) U.S. Cl. CPC G06F 3/0608; G06F 3/0659; G06F 3/0683

(57) ABSTRACT

Embodiments of the present application provide an information processing method and apparatus, and a storage medium. The method comprises: under the condition that information to-be-stored is received, searching a storage cluster for a first storage node containing a main storage label, and storing said information into the first storage node, the main storage label being, when a node of a main storage type is determined from the storage cluster, a label allocated to the node of the main storage type. By means of the technical solution, the purpose of improving the storage efficiency during information storage is achieved.

### CROSS-REFERENCE TO RELATED APPLICATION

The disclosure is filed based on and claims the benefit of priority of the Chinese Patent Application No. 202111542702.9, filed on Dec. 16, 2021, and entitled “Information processing method and device and storage medium”, the disclosure of which is incorporated by reference herein in its entirety.

### TECHNICAL FIELD

Embodiments of the disclosure relate to the field of database, in particular to a method and apparatus for information processing and a storage medium.

### BACKGROUND

Remote Dictionary Server (Redis) is a high-performance, open-source, and key-value pair database with high read and write performance. Redis can save key-value pair data stored in a memory to a hard disk persistently. Different persistence modes can be configured by a user according to actual usage scenarios. In order to improve a storage reliability of Redis, a common choice is to set up a master Redis and a slave Redis in different servers. When the master Redis fails, the slave Redis is switched into a new master Redis to continue to provide storage services to the outside.

However, after switching the slave Redis into the new master Redis, before performing a storage operation, it is necessary to manually modify address information of the original master Redis stored in a client to address information of the new master Redis, which reduces a storage efficiency during information storage.

### SUMMARY

Embodiments of the disclosure provide a method and apparatus for information processing and a storage medium, which can improve the storage efficiency during information storage.

The technical solutions of the disclosure are implemented as follows.

In a first aspect, there is provided a method for information processing in an embodiment of the disclosure, and the method includes the following operations.

A storage cluster is searched for a first storage node containing a master storage label in response to receiving information to-be-stored, and the information to-be-stored is stored into the first storage node. The master storage label is a label allocated to a node of a master storage type when the node of the master storage type is determined from the storage cluster.

In the method for information processing mentioned above, after storing the information to-be-stored into the first storage node, the method may further include the following operations.

The storage cluster is searched for a second storage node corresponding to the first storage node in response to detecting an abnormality in the first storage node, and the master storage label is set for the second storage node. The second storage node is a node of a slave storage type corresponding to the first storage node.

The first storage node is started through new address information in response to acquiring the new address information allocated to the first storage node, and the first storage node is set as a node of the slave storage type through the new address information in response to a completion of the starting of the first storage node.

In the method for information processing mentioned above, after setting the master storage label for the second storage node and before starting the first storage node, the method may further include the following operation.

A first instance is triggered to allocate the new address information to the first storage node when the first instance corresponding to the first storage node has been restarted.

In the method for information processing mentioned above, before searching the storage cluster for the first storage node containing the master storage label in response to the storage cluster receiving the information to-be-stored, the method may further include the following operation.

The master storage label corresponding to the node of the master storage type is allocated to the first storage node in response to determining the node of the master storage type in the storage cluster to be the first storage node.

In a second aspect, there is provided an apparatus for information processing in an embodiment of the disclosure, and the apparatus includes a search module and a storage module.

The search module is configured to search a storage cluster for a first storage node containing a master storage label in response to receiving information to-be-stored.

The storage module is configured to store the information to-be-stored into the first storage node. The master storage label is a label allocated to a node of a master storage type when the node of the master storage type is determined from the storage cluster.

In the apparatus for information processing mentioned above, the apparatus may further include a monitoring cluster and an operation and maintenance module.

The monitoring cluster is configured to search the storage cluster for a second storage node corresponding to the first storage node in response to detecting an abnormality in the first storage node. The second storage node is a node of a slave storage type corresponding to the first storage node.

The operation and maintenance module is configured to: set the master storage label for the second storage node; start the first storage node through new address information in response to acquiring the new address information allocated to the first storage node; and set the first storage node as a node of a slave storage type through the new address information in response to a completion of the starting of the first storage node.

In the apparatus for information processing mentioned above, the apparatus may further include a triggering module.

The triggering module is configured to trigger a first instance to allocate the new address information to the first storage node when the first instance corresponding to the first storage node has been restarted.

In the apparatus for information processing mentioned above, the operation and maintenance module is further configured to allocate the master storage label corresponding to the node of the master storage type to the first storage node in response to determining the node of the master storage type in the storage cluster to be the first storage node.

In a third aspect, there is provided a device for information processing in an embodiment of the disclosure. The device includes a processor, a memory and a communication bus. The processor, when executing an operational program stored in the memory, implements the method for information processing of any one of the above.

In a fourth aspect, there is provided a storage medium having stored thereon a computer program in an embodiment of the disclosure, the computer program, when executed by a processor, causes the processor to implement the method for information processing of any one of the above.

The embodiments of the disclosure provide a method and apparatus for information processing and a storage medium. The method includes: searching a storage cluster for a first storage node containing a master storage label in response to receiving information to-be-stored, and storing the information to-be-stored into the first storage node. The master storage label is a label allocated to a node of a master storage type when the node of the master storage type is determined from the storage cluster. With the above solution, the master storage label is allocated to the storage node, and the master storage node for storing the information to-be-stored can be directly searched from the storage cluster according to the master storage label in response to receiving the information to-be-stored, thereby avoiding the situation in the related art that it is necessary to manually modify the address information of a new storage node in the client after switching the slave storage node to the new master storage node in response to detecting an abnormality in the master storage node, and thus improving the storage efficiency during information storage.

### BRIEF DESCRIPTION OF THE DRAWINGS

FIG. 1 is a flowchart of a method for information processing provided in an embodiment of the disclosure.

FIG. 2 is a schematic diagram of an example for monitoring a storage cluster by a monitoring cluster provided in an embodiment of the disclosure.

FIG. 3 is a timing diagram of an exemplary method for information processing provided in an embodiment of the disclosure.

FIG. 4 is a schematic diagram of a composition structure of an apparatus for information processing provided in an embodiment of the disclosure.

FIG. 5 is a schematic diagram of a composition structure of a device for information processing provided in an embodiment of the disclosure.

### DETAILED DESCRIPTION

It should be understood that the specific embodiments described herein are intended only to explain the disclosure and do not constitute a limitation of the disclosure.

An embodiment of the disclosure provides a method for information processing, executable by an apparatus for information processing. FIG. 1 is a flowchart of a method for information processing provided in an embodiment of the disclosure. As shown in FIG. 1, the method for information processing includes the following operations.

At S101, a storage cluster is searched for a first storage node containing a master storage label in response to receiving information to-be-stored, and the information to-be-stored is stored into the first storage node. The master storage label is a label allocated to a node of a master storage type when the node of the master storage type is determined from the storage cluster.

In the embodiment of the disclosure, the apparatus for information processing searches the storage cluster for the first storage node containing the master storage label in response to receiving the information to-be-stored, and stores the information to-be-stored into the first storage node. The master storage label is a label allocated to a node of a master storage type when the node of the master storage type is determined from the storage cluster.

The method for information processing proposed by the embodiment of the disclosure can be applied to the scenario where information is stored in the storage node.

In an embodiment of the disclosure, the first storage node containing the master storage label is generated before receiving the information to-be-stored. Specifically, the master storage label corresponding to the node of the master storage type is allocated to the first storage node in response to determining the node of the master storage type in the storage cluster to be the first storage node.

It should be noted that the node of the master storage type in the storage cluster is used for providing storage services to the outside, and correspondingly, there is also a node of a slave storage type in the storage cluster. The node of the slave storage type does not need to provide services to the outside, but needs to copy information from the corresponding node of the master storage type in real time in order to keep information synchronization between the node of the master storage type and the node of the slave storage type, so that subsequent storage tasks can be processed by the node of the slave storage type when the node of the master storage type is restarted in response to detecting an abnormality.

It should be noted that one node of the master storage type corresponds to one or more nodes of the slave storage type. The specific correspondences can be determined according to the actual situation, which is not specifically limited in the disclosure.

In the embodiment of the disclosure, after storing the information to-be-stored into the first storage node, if an abnormality is detected in the first storage node, it is necessary to replace the node of the master storage type to provide the subsequent storage services at this time. Specifically, the storage cluster is searched for a second storage node corresponding to the first storage node in response to detecting an abnormality in the first storage node, and the master storage label is set for the second storage node. The first storage node is started through new address information in response to acquiring the new address information allocated to the first storage node, and the first storage node is set as a node of a slave storage type through the new address information in response to a completion of the starting of the first storage node.

In the embodiment of the disclosure, the address information is an Internet Protocol Address (IP address).

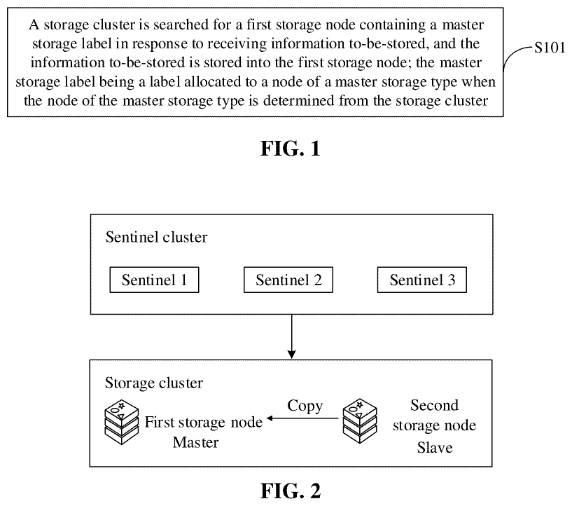

It should be noted that FIG. 2 is a schematic diagram of an example for monitoring the storage cluster by a monitoring cluster provided in an embodiment of the disclosure. As shown in FIG. 2, the monitoring cluster includes multiple sentinels for monitoring the storage cluster. Since the address information of each storage node in the storage cluster is stored in the monitoring cluster, the storage node can be monitored by the address information. Further, the storage cluster is searched for the second storage node corresponding to the first storage node according to the address information of the storage node in response to detecting an abnormality in the first storage node.

It should be noted that the number of sentinels in the monitoring cluster may be one or more, and the specific number is determined according to the actual situation, which is not specifically limited in the disclosure.

It should be noted that the second storage node is one of the nodes of the slave storage type corresponding to the first storage node. Since the first storage node may correspond to one or more nodes of the slave storage type, one of the multiple nodes of the slave storage type may be randomly selected as the second storage node when one storage node corresponds to multiple nodes of the slave storage type.

In the embodiment of the disclosure, the new address information is reallocated for the first storage node by a first instance. Specifically, the first instance is triggered to allocate the new address information for the first storage node when the first instance corresponding to the first storage node has been restarted.

It should be noted that, since the storage node in the disclosure is a containerized Redis, the address information of the storage node is virtual address information. When the instance where the containerized Redis is deployed is restarted in response to detecting an abnormality, the address information will be reallocated for the containerized Redis.

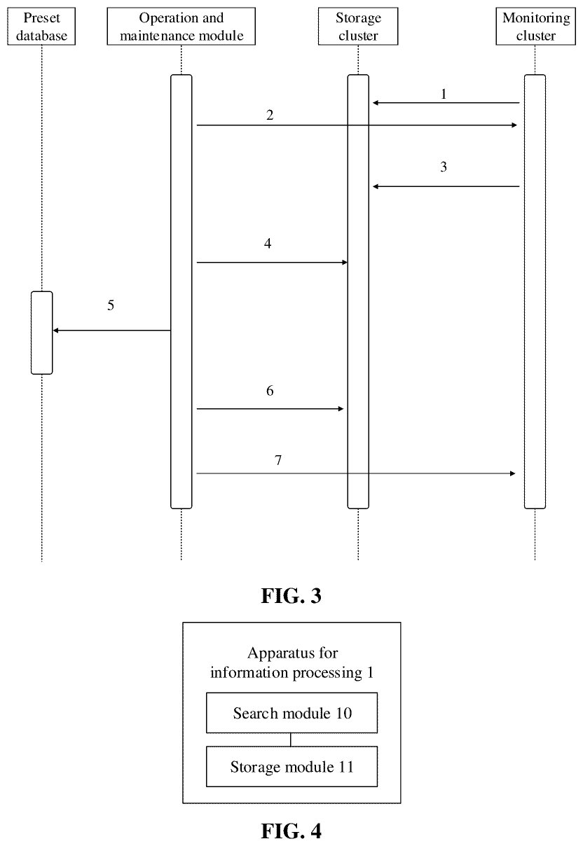

In a practical application, FIG. 3 is a timing diagram of an exemplary method for information processing provided in the disclosure. As shown in FIG. 3, the present embodiment exemplifies the disclosure by means of FIG. 3.

1. The monitoring cluster monitors the storage cluster.

It should be noted that, since the address information of each storage node in the storage cluster is stored in the monitoring cluster, a working state of each storage node in the storage cluster can be monitored in real time.

2. An operation and maintenance module monitors the monitoring cluster.

It should be noted that the operation and maintenance module is configured to assist the monitoring cluster in switching between the node of the master storage type and the node of the slave storage type.

3. The monitoring cluster triggers the switching between the node of the master storage type and the node of the slave storage type in response to detecting that the instance where the master storage node is deployed is restarted due to an abnormality in the master storage node in the storage cluster.

It should be noted that, at this time, due to the restart of the instance where the master storage node is deployed, the new address information will be reallocated to the master storage node. At this time, since only old address information of the master storage node is stored in the monitoring cluster, the master storage node cannot continue to be monitored. The storage cluster is searched for the slave storage node corresponding to the master storage node, and the slave storage node is regarded as a new master storage node in the storage cluster.

4. The operation and maintenance module allocates a master storage label to the new master storage node in response to detecting that the monitoring cluster has completed the switching between the node of the master storage type and the node of the slave storage type.

It should be noted that at this time, the apparatus for information processing directly sends information to-be-stored to the new master storage node containing the master storage label for storage when receiving the information to-be-stored.

5. The operation and maintenance module acquires the new address information of the original master storage node from a preset database.

It should be noted that the preset database may be a distributed key-value database ETCD, and the specific preset database may be determined according to the actual situation, which is not specifically limited in the disclosure.

It should be noted that the new address information of the original master storage node in the preset database is acquired by an address information detection module. The address information detection module is configured to monitor the instance where the storage node is deployed. After the instance is restarted and new address information is reallocated for the storage node, the address information detection module will acquire the new address information and store it in the ETCD correspondingly, so that the operation and maintenance module can acquire the new address information from the preset database.

It should be noted that when the operation and maintenance module acquires the new address information of the original master storage node from the preset database, it means that the restarting of the instance where the original master storage node is deployed has been completed.

6. The operation and maintenance module starts the original master storage node in the instance, and allocates a slave storage label to the original master storage node.

It should be noted that, when the operation and maintenance module acquires the new address information of the original master storage node from the preset database, it means that the restarting of the instance where the original master storage node is deployed has been completed, so the original master storage node in the instance can be started. After the starting of the original master storage node is completed, the slave storage label is allocated to the original master storage node to indicate that the original master storage node is a node of the slave storage type in the storage cluster at this time, and the original master storage node needs to copy information from the new master storage node in real time in order to keep information synchronization.

7. The operation and maintenance module transmits the new address information of the original master storage node to the monitoring cluster, so that the monitoring cluster can monitor the original master storage node based on the new address information of the original master storage node.

It should be noted that the operation and maintenance module needs to clear historical address information of the original master storage node stored in the monitoring cluster before transmitting the new address information of the original master storage node to the monitoring cluster, and then transmits the new address information.

The embodiment of the disclosure provides a method for information processing. The method includes: searching the storage cluster for the first storage node containing the master storage label in response to receiving the information to-be-stored, and storing the information to-be-stored into the first storage node. The master storage label is a label allocated to a node of a master storage type when the node of the master storage type is determined from the storage cluster. With the above solution, the master storage label is allocated to the storage node, and the master storage node for storing the information to-be-stored can be directly searched from the storage cluster according to the master storage label in response to receiving the information to-be-stored, thereby avoiding the situation in the related art that it is necessary to manually modify address information of a new storage node in the client after switching the slave storage node to the new master storage node in response to detecting an abnormality in the master storage node, and thus improving the storage efficiency during information storage.

Based on the above-described embodiment, another embodiment of the disclosure provides an apparatus 1 for information processing. FIG. 4 is a schematic diagram of a composition structure of an apparatus for information processing provided in the disclosure. As shown in FIG. 4, the apparatus 1 for information processing includes a search module 10 and a storage module 11.

The search module 10 is configured to search a storage cluster for a first storage node containing a master storage label in response to receiving information to-be-stored.

The storage module 11 is configured to store the information to-be-stored into the first storage node. The master storage label is a label allocated to a node of a master storage type when the node of the master storage type is determined from the storage cluster.

Optionally, the apparatus 1 for information processing further includes: a monitoring cluster and an operation and maintenance module.

The monitoring cluster is configured to search the storage cluster for a second storage node corresponding to the first storage node in response to detecting an abnormality in the first storage node. The second storage node is a node of a slave storage type corresponding to the first storage node.

The operation and maintenance module is configured to: set the master storage label for the second storage node; start the first storage node through new address information in response to acquiring the new address information allocated to the first storage node; and set the first storage node as a node of a slave storage type through the new address information in response to a completion of the starting of the first storage node.

Optionally, the apparatus 1 for information processing further includes a trigger module.

The triggering module is configured to trigger a first instance to allocate the new address information to the first storage node when the first instance corresponding to the first storage node has been restarted.

Optionally, the operation and maintenance module is further configured to allocate the master storage label corresponding to the node of the master storage type to the first storage node in response to determining the node of the master storage type in the storage cluster to be the first storage node.

The embodiment of the disclosure provides an apparatus for information processing. The apparatus is configured to: search the storage cluster for the first storage node containing the master storage label in response to receiving the information to-be-stored, and store the information to-be-stored into the first storage node. The master storage label is a label allocated to a node of a master storage type when the node of the master storage type is determined from the storage cluster. With the above solution, the master storage label is allocated to the storage node, and the master storage node for storing the information to-be-stored can be directly searched from the storage cluster according to the master storage label in response to receiving the information to-be-stored, thereby avoiding the situation in the related art that it is necessary to manually modify address information of a new storage node in the client after switching the slave storage node to the new master storage node in response to detecting an abnormality in the master storage node, and thus improving the storage efficiency during information storage.

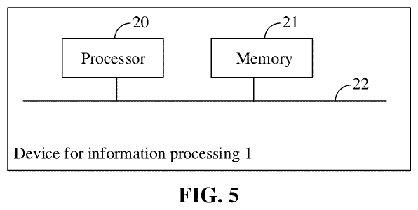

FIG. 5 is a schematic diagram of a composition structure of a device for information processing provided in an embodiment of the disclosure. In a practical application, as shown in FIG. 5, the device 2 for information processing in this embodiment includes a processor 20, a memory 21, and a communication bus 22, based on the above-described embodiment under the same disclosure concept.

In the process of specific implementation, the search module 10, the memory module 11, the monitoring cluster, the operation and maintenance module, and the trigger module mentioned above may be implemented by the processor 20 in the device 2 for information processing. The processor 20 may be at least one of: an application specific integrated circuit (ASIC), a digital signal processor (DSP), a digital signal processing device (DSPD), a programmable logic device (PLD), a field programmable gate array (FPGA), a CPU, a controller, a microcontroller, and a microprocessor. It is understandable that for different devices for information processing, the electronic device for implementing the above processor functions may also be other devices, which is not specifically limited in the embodiment.

In the embodiment of the disclosure, the above-described communication bus 22 is configured to implement connection and communication between the processor 20 and the memory 21. The processor 20, when executing an operational program stored in the memory 21, implements the method for information processing as follows.

A storage cluster is searched for a first storage node containing a master storage label in response to receiving information to-be-stored, and the information to-be-stored is stored into the first storage node. The master storage label is a label allocated to a node of a master storage type when the node of the master storage type is determined from the storage cluster.

Optionally, the processor 20 is further configured to: search the storage cluster for a second storage node corresponding to the first storage node in response to detecting an abnormality in the first storage node, and set the master storage label for the second storage node, the second storage node being a node of a slave storage type corresponding to the first storage node; start the first storage node through new address information in response to acquiring the new address information allocated to the first storage node; and set the first storage node as a node of a slave storage type through the new address information in response to a completion of the starting of the first storage node.

Optionally, the processor 20 is further configured to trigger a first instance to allocate the new address information to the first storage node when the first instance corresponding to the first storage node has been restarted.

Optionally, the processor 20 is further configured to allocate the master storage label corresponding to the node of the master storage type to the first storage node in response to determining the node of the master storage type in the storage cluster to be the first storage node.

An embodiment of the disclosure provides a storage medium having stored thereon a computer program. The computer-readable storage medium stores one or more programs, which is executable by one or more processors and applicable to an apparatus for information processing, and the computer program implements the method for information processing as described above.

It should be noted that the terms “including”, “containing” or any other variation thereof are intended to encompass non-exclusive inclusion herein, so that a process, a method, an object or an apparatus that includes a series of elements includes not only those elements but also other elements that are not explicitly listed or elements that are inherent in the process, the method, the object or the apparatus. Without further limitation, the element limited by the phrase “includes a . . . ” does not preclude the existence of another identical element in the process, the method, the object or the apparatus in which the element is included.

From the description of the above embodiments, those skilled in the art can clearly understand that the method in the above embodiments can be implemented by means of software plus a necessary general hardware platform, and of course can be implemented by means of hardware, but the former is a better embodiment in many cases. Based on this understanding, the technical solutions of the disclosure in nature or the part of the technical solutions that contributes to the related art may be embodied in the form of a software product stored in a storage medium (e.g. ROM/RAM, magnetic disk, optical disc). The storage medium includes instructions which enable an image display device (which may be a handset, a computer, a server, an air conditioner, or a network device, etc.) to execute the method for information processing described in various embodiments of the disclosure.

The above are only preferred embodiments of the disclosure and are not intended to limit the scope of protection of the disclosure.

1. A method for information processing, executable by an apparatus for information processing, the method comprising:
searching a storage cluster for a first storage node containing a master storage label in response to receiving information to-be-stored, and storing the information to-be-stored into the first storage node, the master storage label being a label allocated to a node of a master storage type when the node of the master storage type is determined from the storage cluster.

2. The method of claim 1, wherein after storing the information to-be-stored into the first storage node, the method further comprises:
searching the storage cluster for a second storage node corresponding to the first storage node in response to detecting an abnormality in the first storage node, and setting the master storage label for the second storage node, the second storage node being a node of a slave storage type corresponding to the first storage node; and
starting the first storage node through new address information in response to acquiring the new address information allocated to the first storage node, and setting the first storage node as a node of the slave storage type through the new address information in response to a completion of the starting of the first storage node.

3. The method of claim 2, wherein after setting the master storage label for the second storage node and before starting the first storage node, the method further comprises:
triggering a first instance to allocate the new address information to the first storage node when the first instance corresponding to the first storage node has been restarted.

4. The method of claim 2, wherein before searching the storage cluster for the first storage node containing the master storage label in response to receiving the information to-be-stored, the method further comprises:
allocating the master storage label corresponding to the node of the master storage type to the first storage node in response to determining the node of the master storage type in the storage cluster to be the first storage node.

5. An apparatus for information processing, comprising:
a memory for storing a computer program; and
a processor,
wherein the processor is configured to execute the computer program stored in the memory to:
search a storage cluster for a first storage node containing a master storage label in response to receiving information to-be-stored; and
store the information to-be-stored into the first storage node, the master storage label being a label allocated to a node of a master storage type when the node of the master storage type is determined from the storage cluster.

6. The apparatus of claim 5, further comprising:
a monitoring cluster, configured to search the storage cluster for a second storage node corresponding to the first storage node in response to detecting an abnormality in the first storage node, the second storage node being a node of a slave storage type corresponding to the first storage node; and
the processor being further configured to: set the master storage label for the second storage node; start the first storage node through new address information in response to acquiring the new address information allocated to the first storage node; and set the first storage node as a node of a slave storage type through the new address information in response to a completion of the starting of the first storage node.

7. The apparatus of claim 6, wherein the processor is further configured to:
trigger a first instance to allocate the new address information to the first storage node when the first instance corresponding to the first storage node has been restarted.

8. The apparatus of claim 6, wherein the process is further configured to allocate the master storage label corresponding to the node of the master storage type to the first storage node in response to determining the node of the master storage type in the storage cluster to be the first storage node.

9. (canceled)

10. A non-transitory computer-readable storage medium having stored thereon a computer program that, when executed by a processor, causes the processor to implement operations comprising:
searching a storage cluster for a first storage node containing a master storage label in response to receiving information to-be-stored, and storing the information to-be-stored into the first storage node, the master storage label being a label allocated to a node of a master storage type when the node of the master storage type is determined from the storage cluster.

11. The non-transitory computer-readable storage medium of claim 10, wherein after storing the information to-be-stored into the first storage node, the operations further comprise:
searching the storage cluster for a second storage node corresponding to the first storage node in response to detecting an abnormality in the first storage node, and setting the master storage label for the second storage node, the second storage node being a node of a slave storage type corresponding to the first storage node; and
starting the first storage node through new address information in response to acquiring the new address information allocated to the first storage node, and setting the first storage node as a node of the slave storage type through the new address information in response to a completion of the starting of the first storage node.

12. The non-transitory computer-readable storage medium of claim 11, wherein after setting the master storage label for the second storage node and before starting the first storage node, the operations further comprise:
triggering a first instance to allocate the new address information to the first storage node when the first instance corresponding to the first storage node has been restarted.

13. The non-transitory computer-readable storage medium of claim 10, wherein before searching the storage cluster for the first storage node containing the master storage label in response to receiving the information to-be-stored, the operations further comprise:
allocating the master storage label corresponding to the node of the master storage type to the first storage node in response to determining the node of the master storage type in the storage cluster to be the first storage node.
